(19) United States
(12) Patent Application Publication
(10) Pub. No.: US 2008/0147444 A1
(43) Pub. Date: Jun. 19, 2008

(54) Blood product utilization system and methods

(76) Inventors: David F. Jadwin, Glendale, CA (US); Steven L. Bennett, Incline Village, NV (US)

Correspondence Address: LAUSON & SCHEWE LLP, 1600 ROSECRANS AVENUE 4TH FLOOR, FOURTH FLOOR, MANHATTAN BEACH, CA, 90266, US

(21) Appl. No.: 11/983,077

(22) Filed: Nov. 6, 2007

Related U.S. Application Data
(60) Provisional application No. 60/856,976, filed on Nov. 6, 2006.

(51) Int. Cl. G06Q 50/00

(52) U.S. Cl. 705/3

(57) ABSTRACT

A method and system is provided featuring a computer database containing select clinical observations and laboratory data for each of a number of patients in conjunction with healthcare provided such as blood product transfusion utilization for each patient. Particularly, the database is accessible remotely such as via the worldwide web. The method and system is particularly useful for review of health care provided such as the appropriateness of blood product utilization and allows patterns of utilization by individual healthcare providers or healthcare institutions to be determined on a confidential basis.

### RELATED APPLICATION DATA

This application claims the benefit of U.S. provisional application Ser. No. 60/856,976, filed Nov. 6, 2006, entitled Blood Product Utilization System.

### BACKGROUND OF THE INVENTION

1. Field of the Invention

The present invention relates to a method for using a computer system comprising computer software preferably in conjunction with the worldwide web to determine whether utilization of a medical product such as transfusion with a blood product is appropriate or to assess the utilization history of an individual healthcare provider or healthcare institution.

2. Description of the Related Art

The United States ranks first in the world in per-capita health care expenditures. At a time when national health care costs continue to escalate at an alarming rate, managed-care companies and the government have been successful in holding down payments to hospitals. Providing medical care requires collecting an extensive amount of patient information.

Currently, some existing hospital tracking systems allow medical staff to enter and view information in a flowsheet format and organize general patient information in a manner that is useful for the particular medical setting. Other systems allow a user to define a particular set of parameters to be followed throughout the treatment. For example, U.S. Pat. No. 5,682,526 discloses a method, in a computer system under user control, for flexibly organizing, recording and displaying medical patient care information using fields in a flowsheet. The method allows a user to customize flow sheets and define parameters of medical procedures and values as needed by the particular health care facility. Further, the system allows a user to add results to the existing flowsheet from various tests conducted. However, the system of the '526 patent does not allow a user to track cumulative patient and physician activity or analyze treatment periods.

U.S. Pat. No. 6,125,350 is directed to a method of providing a computer operated medical information log system comprising user defined input concerning medical procedures, routing of patients, attending physicians or residents, codes for billing, methods of providing a medical information log system useful in tracking data in a surgical outpatient environment for the purpose of record keeping, outcome analysis, research, teaching, quality assurance, or billing, etc.

U.S. Pat. No. 5,812,984 discloses a method for entering user defined medical information (e.g. patient history, test results, medical findings etc.), into an electronic patient chart, the primary purpose of which is to streamline the process of updating previously handwritten charts of those patients transferred between hospital departments. However, the method of the '984 patent does not mention how data electronically recorded within the patient charts may be subsequently used to evaluate department activity or transfusion usage.

U.S. Pat. No. 5,950,168 is directed toward a collapsible flowsheet for displaying patient information in an electronic medical record. The purpose of this is to provide an improved user interface for use by a healthcare provider in maintaining and viewing information from an electronic medical record.

U.S. Pat. No. 5,760,704 discloses an electronic tracking system developed for use primarily in a hospital emergency room facility. This system expedites the handling and manipulation of patient information by electronically updating patient charts. The system of the patent consists of multiple modules connected to multiple peripheral stations to allow simultaneous use by medical staff. The system requires extensive hardware to operate which, in turn, necessitates a substantial financial investment by a purchaser.

WO 97/06498 discloses a method for integrating and displaying various kinds of medical data collected at irregular intervals in a flowsheet, by doctors, nurses, laboratory personnel and other medical staff. The flowsheet lists parameters (e.g. blood sugar level, urine volume etc.) that medical personnel monitor over a time period (e.g hourly, daily, monthly etc.) for a given patient. The flowsheet allows for the collection of data from multiple patients and a comparison of changes in selected clinical and therapeutic data within a given time period for a particular problem. The primary function of this system is to allow medical personnel to monitor the progress of patients as they progress through treatment. Additionally, the invention may be used in long term medical studies or drug treatment evaluations.

Blood products include whole blood (blood with all of its components), packed red blood cells, platelets, plasma, and concentrated clotting factors. When packed red blood cells are transfused, an individual's blood count increases. This blood count is usually measured as the hemoglobin level. Normal hemoglobin levels are about 12 to 15 grams per 100 milliliters of blood for women and about 14 to 17 for men. Although individual circumstances can be different, anemia (low red blood cell count) requiring transfusion usually occurs when the hemoglobin is about 7. Medical research has shown that significant decreases in tissue oxygen delivery occur when the hemoglobin drops to that level. Reasons for blood transfusion include blood loss from injuries or internal bleeding, blood loss during and after surgery, including organ transplantation, treatment for leukemia and other types of cancers, anemia caused by illnesses, and bleeding disorders.

The main health risks associated with transfusions include transfusion reactions from incompatible blood, transmission of an infectious disease, immune reactions such as anaphylaxis, graft versus host disease, irregular antibody formation, and immune suppression, and toxic injury such as acute transfusion associated lung injury and hyperkalemia. Because of the risk of infections from blood or blood products, each unit of donated blood is carefully tested for the presence of viruses (including hepatitis viruses, the human immunodeficiency virus (HIV), cytomegalovirus, and West Nile virus) and the organism that causes syphilis. With this extensive testing, the chance of receiving a unit of blood containing the human immunodeficiency virus is now less than 1 in 1.9 million, and the risk of exposure to the hepatitis C virus is less than 1 in 1 million.

Blood acquisition costs have more than doubled in the past few years and will continue to rise as the blood supply struggles to meet increasing demand. Each transfusion causes a stepwise increase in serious complications including postoperative infection rates, ventilator-acquired pneumonia, central line sepsis, ICU and hospital length of stay, as well as mortality rates. It has been reported that transfusion costs exceed blood acquisition costs by four times or greater when accounting for labor, supplies, administration and adverse events. Further, many physicians who order blood products lack formal training in transfusion therapy and are unaware of current transfusion guidelines. Oversight of blood utilization is lacking as evidenced by wide variation in transfusion practices between institutions and among physicians at the same institution.

It would be desirable to develop a blood management oversight program that allows rapid assessment of individual blood transfusion needs as well as historical blood usage patterns for an individual healthcare provider or healthcare institution so as to promote the safe and optimal use of blood and its associated resources. Such an oversight program serves to reduce variation in transfusion practice and implement more efficient methods to manage patients at risk for transfusion. Because of the tremendous cost of blood transfusions and transfusion-associated adverse events, cost savings realized by blood management programs are large.

In 1995, one study reported results of an audit of blood product use at a tertiary teaching hospital (Royal Melbourne Hospital, Victoria). Indications for transfusion were analyzed, mainly by retrospective review of medical records. The study found that blood product use was inappropriate for 16% of red cell, 13% of platelet and 31% of fresh frozen plasma (FFP) transfusion episodes. In a significant number of episodes, the specific indication for transfusion was not documented in the medical record. Minimizing unnecessary use of blood products minimizes patient exposure to potential hazards as well as contains costs. Tuckfield et al., Med. J. Australia, 1997, 167:473-476.

Computer database systems containing records on recipients of blood and blood products together with details of the products transfused have been developed. The primary purposes of such databases are to facilitate retrospective analysis of patients and products and to provide a data source for blood utilization monitoring and planning purposes. The data collected in such databases normally includes identification of the facility reporting the transfusion, recipient identification, including name, hospital chart number and date of birth, and identification of all blood, blood components and fractionated blood products used (whether transfused, destroyed or shipped), with identifiers to trace back to the source of the product. Hospitals that have a computerized record system in their blood bank usually extract the relevant data and format it to a standardized record for transmission on a regular basis. Historically, such databases are not online databases. However, such databases are valuable to provide information concerning product disposition detail, summaries of utilization by a facility over a reporting period, transfusion profiles of a given recipient, and tracking of individual units. As a result, reports can be generated by product, by disposition, by hospital and by region to produce more tailored information.

It would be a major advancement to provide a computer database containing select clinical observations and laboratory data for each patient in conduction with blood product transfusion utilization for each patient. Particularly, it would be a major advancement to make such a database accessible remotely such as via the worldwide web. This would facilitate review of the appropriateness of blood product utilization and allow patterns of utilization by individual healthcare providers or healthcare institutions to be determined. Such information would prove highly useful in educating healthcare providers and institutions regarding proper utilization as understood by contemporary medical standards and would therefore avoid many unnecessary transfusion events.

### SUMMARY OF THE INVENTION

In a first aspect, the present invention provides a method of assessing or tracking the utilization of a medical product by a healthcare provider or healthcare institution. In embodiments of the invention, the medical product is blood or a blood product used in a transfusion of a patient. The method comprises entering relevant laboratory or clinical information regarding the patient into a database. The relevant laboratory or clinical information may include, for instance, a patient's hemoglobin or hematocrit levels, platelet count, age, blood pressure, weight, pulse, estimated blood loss, PT/PTT/Fibrinogen, pharmacologic treatment, and intravenous fluid administration. The levels may be taken before, during or after transfusion with a blood product. In the instance where an assessment of the appropriateness of a transfusion is made, the relevant laboratory or clinical information is reviewed by a clinical reviewer against a standard set of criteria. In embodiments, the clinical reviewer accesses the relevant laboratory or clinical information regarding the patient from the database remotely, such as via the worldwide web. The relevant laboratory or clinical information regarding the patient may be organized in a fashion so as to facilitate and expedite the review. Further, in some instances, a given laboratory value or clinical observation may be assigned a score according to a category into which it is assigned relative to similar laboratory values or clinical observations of the same patient or a group of patients.

In a second aspect, the present invention provides a method for assessing the appropriateness of or need for using a medical product or care provided by a healthcare provider or healthcare institution. In one or more embodiments, the medical product is blood or a blood product used in a transfusion of a patient. The method comprises entering relevant laboratory or clinical information regarding the patient into a database. The relevant laboratory or clinical information may include, for instance, a patient's hemoglobin or hematocrit levels, platelet count, age, blood pressure, weight, and PT/PTT/Fibrinogen. The levels may be taken before, during or after transfusion with a blood product. In the instance where an assessment of the appropriateness of a transfusion is made, the relevant laboratory or clinical information or both is reviewed by a clinical reviewer against a standard set of criteria. Any transfusion that falls outside of the initial screening criteria may be noted for further review. In general, the transfusion decision may be determined to be sound based upon further evaluation or found to be unwarranted. In embodiments of the invention, the clinical reviewer accesses the relevant laboratory or clinical information regarding the patient from the database remotely, such as via the worldwide web. The relevant laboratory or clinical information regarding the patient may be organized in a fashion so as to facilitate and expedite the review. Further, in some instances, a given laboratory value or clinical observation may be assigned a score according to a category into which it is assigned relative to similar laboratory values or clinical observations of the same patient or a group of patients.

In a third aspect, the present invention provides a programmable computer system for use in determining whether transfusion with a blood product is or was appropriate, comprising a central processing unit, a system memory, a display device, an input device, and a control device, wherein said central processing unit comprises a software application capable of generating a display of medical data; said central processing unit further comprises an operating system capable of interfacing with said software application; said system memory capable of storing data in user-defined, sortable databases; said control device capable of directing activity of said software application. In many instances, the software application is capable of assigning a clinical score in response to one or more relevant laboratory or clinical information data and wherein said clinical score is indicative of the degree transfusion with a blood product is or was warranted. The operating system may be Macintosh, DOS, Windows, Windows NT, OS/2, OS/3, Unix and the like. The input device may be, for example, a keyboard, bar code reader, touch screen, voice recognition and combinations thereof. The system memory may be, for instance, a system hard drive. The computer system may optionally contain an auxiliary memory that may be, for instance, a floppy disk, CD Rom, Internet server memory storage device, network drive, or server.

In a fourth aspect, the present invention provides a medical information database in a programmable computer system for use in tracking or evaluating transfusion activity wherein the medical information database is accessible by at least one external reviewer via the worldwide web. The medical information database may contain details of each patient including age, diagnosis, weight, and at least one of hemoglobin or hematocrit levels, platelet count, blood pressure, weight, pulse, estimated blood loss, PT, PTT, and fibrinogen levels. Further, the medical information database may contain details of each transfusion event with each blood product.

In a fifth aspect, the present invention provides an improved patient medical information database for use in evaluating blood product transfusion of a healthcare provider or healthcare institution, wherein the improvement comprises a communication link whereby the information database is accessible remotely or via the worldwide web.

In a sixth aspect, embodiments of the invention include redaction of confidential information. Current redaction programs are used to locate and mask confidential patient names in an effort to redact HIPAA confidential information. Embodiments of the invention include a strategy to protect confidential information not only of the patient, but that of the healthcare institutions and physician providers rendering patient care. This strategy permits internet review of medical records by external examiners performing utilization and peer review. Otherwise, irrespective of HIPAA considerations, hospitals and physicians generally would not allow their personal performance to undergo external public scrutiny for fear of negative social and economic reaction.

The inventive redaction process relies on three steps to mask not only the identity of the patient, but the names of treating physicians, the name of the treating facility and the geographic location of the treating facility. The first step involves the application of black opaque image masks over identification regions on standard hospital forms. Such masks are mapped to areas of the form that contain the patient identification label, other locations of the patient and of treating physicians, the name of the healthcare facility, the address or geographic location of the healthcare facility, and healthcare facility form numbers.

The second step includes the scanning of medical records via the Internet to a remote location and redistribution of record images to a quality control technician that is unaware of the origin of the record from within or even outside of the United States and Canada. Without a geographic point of reference, the identity of information in the record image is essentially hidden from detection.

The third step includes the application of red opaque image masks to any extraneous identifying information. Such information may be visible as a result of rare misapplication of the black image mask to standard forms, the presence of confidential information in non-standard forms, or the inclusion of hand-written information in unmasked regions of the form. By the end of this process all patient, physician, facility and geographic information is redacted. Fully redacted record images are then ready for distribution again via the internet to external utilization and peer reviewers for evaluation. The three step process of application of black opaque image masks, distribution of the masked records to a remote geographic location, and the application of final red opaque image masks prior to external evaluation ensures virtual confidentiality for the patient, the physicians and the healthcare facility.

These and other aspects and advantages of the present invention will become apparent to those skilled in the art upon a reading of the following detailed description of the invention, and the claims appended hereto.

### BRIEF DESCRIPTION OF THE DRAWINGS

FIG. 1 is a diagram demonstrating the assembling of clinical or laboratory information into a central data storage system according to embodiments of the present invention.

FIG. 2 is a diagram showing use of the clinical or laboratory information from a central data storage system according to FIG. 1 by one or more external reviewers to obtain a consensus opinion regarding whether a transfusion event is or was appropriate.

FIG. 3 is a diagram showing analysis results and information distribution according to embodiments of the present invention.

FIG. 4 is a diagram showing document scan and an upload process according to embodiments of the present invention.

FIG. 5 is a diagram of an embodiment of a sample masked patient record according to embodiments of the present invention.

FIG. 6 is a diagram of a further embodiment of a sample masked patient record according to embodiments of the present invention.

FIG. 7 is a diagram showing data entry, chart review and a feedback process according to embodiments of the present invention.

### DETAILED DESCRIPTION OF EMBODIMENTS OF THE INVENTION

The present invention provides for assimilating clinical data into a database that may be accessed remotely such as via the worldwide web. The data assimilated facilitates rapid review by outside clinicians to determine whether use of a medical product such as transfusion with a blood product is warranted prior to the event or to retrospectively determine whether a transfusion was appropriate. Further, the data, once assimilated, may be analyzed to determine transfusion statistics and patterns for any individual healthcare provider or healthcare institution. Moreover, the data, once assimilated may be used to assess performance of a healthcare provider or a healthcare institution.

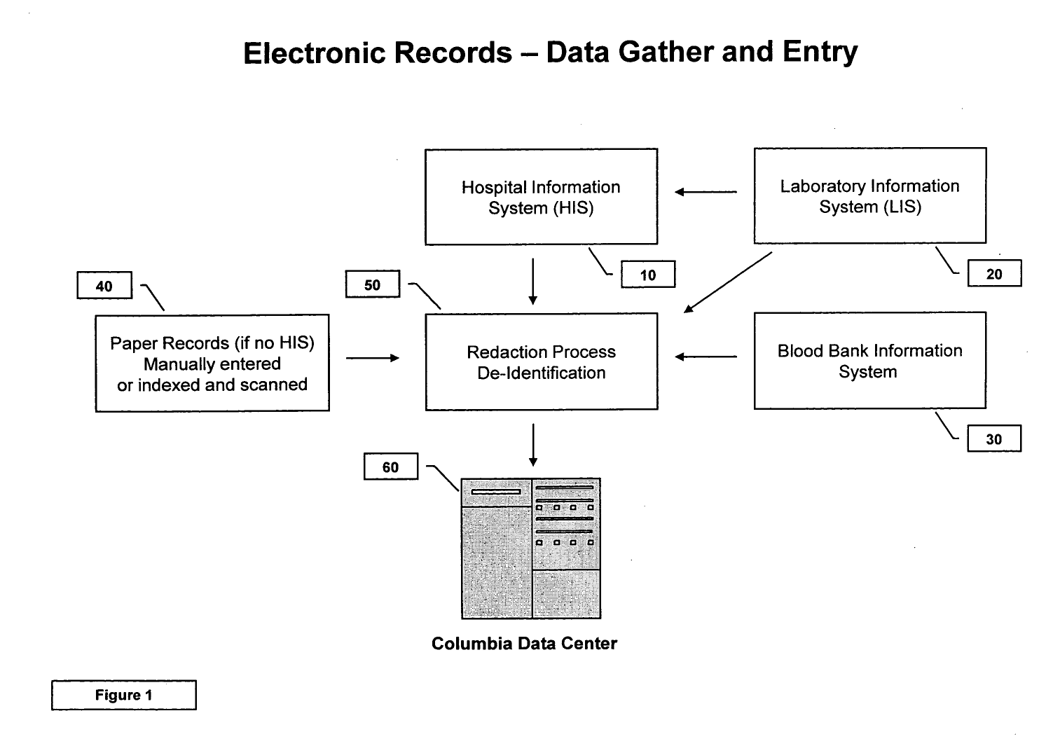

The relevant laboratory results and clinical observations for each patient are collected in a central computer database. As shown in an embodiment of the invention in FIG. 1, this includes data from a hospital information system (HIS) 10, from a laboratory information system (LIS) 20, from a blood bank information system 30 and from paper records 40 if there are insufficient or inadequate electronic records. The data goes through a redaction process 50 to remove indentifying information and then is collected in the database 60. The laboratory results and clinical observations may include the patient's hemoglobin or hematocrit levels, platelet count, age, blood pressure, weight, pulse, estimated blood loss, prothrombin time (PT), PTT, and fibrinogen levels. The levels may be taken before, during or after transfusion with a blood product. The clinical reviewer may access the relevant laboratory or clinical information regarding the patient from the database remotely, such as via the worldwide web. The relevant laboratory or clinical information regarding the patient is organized in a fashion so as to facilitate and expedite the review. A given laboratory value or clinical observation may be assigned a score according to a category into which it is assigned relative to similar laboratory values or clinical observations of the same patient or a group of patients. Tables 1, 4, 5 and 6 represent such collections of data presented in an easily readable form as organized by software.

TABLE 1
Unit Number:
Review Number(s):
Diagnoses Age:

| | | | | | | ok | ok | | | |
|---|---|---|---|---|---|---|---|---|---|---|
| | | ok | | Unit | ok | BP | BP | | ok | ok |
| Date and Time | Event | EBL | Product | # | Pulse | s | d | HGB | PLT | PT |
| 12:15 | | | | | | | | | | |
| 14:15 | | | PLT | | | | | | 9000 | |
| 16:30 | | 1600 | | 1 | 71 | 111 | 75 | | | |
| 16:35 | Admitted | | | | | | | 7.5 | | |
| 17:30 | | 1900 | PRBC | | 72 | 115 | 58 | 6 | | |
| 18:30 | | | PRBC | | 99 | 119 | 54 | | | |
| 20:13 | | | | | | | | 8.7 | 103 | |
| 21:05 | | 1600 | PRBC | | 82 | 82 | 47 | | | |
| 22:00 | | 1100 | PRBC | | 121 | 150 | 61 | | | |
| 22:40 | | | | | 83 | 151 | 68 | | | |
| 23:10 | | | | | | | | | | |
| 23:59 | | 1400 | FFP | | 101 | 110 | 59 | | 60000 | 14 |

TABLE 2
Since there was no product infused, do not reference PRBC logic check.
Regular black text is
checked.
If there is no
product,

then, only check the italicized logic

if there is product,

check both the bold and italicized
logic

if Product is Fresh Frozen Plasma, look at past 24 hours regardless of
prior/other products

and check both italicized and bold

logic
if no product, just check to see if current Platelet count is
<10,000
If product only without any statistics, color product

Table 2 represents a flow of the decision making process for evaluating the appropriateness of a blood product transfusion.

TABLE 3
Logic Key

| | |
|---|---|
| Estimated | EBL > 1800 and age < 30 |
| Blood Loss | EBL > 1300 and age > 55 |
| (EBL) Logic | EBL < 1500 prior to PRBC transfusion and age < 30 |
| | EBL < 1000 prior to PRBC transfusion and age > 55 |
| Pulse Logic | P > 120 (if no product) |
| | Pulse < 100 six hours prior to PRBC transfusion, |
| | P > 120 |
| BP (systolic) | BP < 80/ |
| Logic | BP > 110/six hours prior to PRBC transfusion |
| BP (diastolic) | BP </50 |
| Logic | BP >/60 six hours prior to PRBC transfusion |
| Hemoglobin | HGB < 6.0 and age < 30 |
| (HGB) Logic | HGB < 7.0 and > 55 |
| | HGB > 8.7 six hours prior to PRBC transfusion and |
| | age > 55 |
| | HGB > 6.5 prior to PRBC transfusion and age < 30 |
| Platelet (PLT) | PLT < 10,000 |
| Logic | PLT > 50,000 within 24 hours of PLT transfusion |
| Platelet (PLT) | PLT < 18.1 |
| Logic | PT < 15.1 within 6 hours of FFP transfusion |

Table 3 indicates the parameters evaluated or logic key used in evaluating a transfusion event.
Tables 4, 5 and 6, following, represent collections of data presented in an easily readable form as organized by software and useful for determining appropriateness of blood product utilization.

TABLE 4

| | | | | Unit | | BP | BP | | | | |
|---|---|---|---|---|---|---|---|---|---|---|---|
| Time | Event | EBL | Product | # | Pulse | s | d | HGB | PLT | PT | PCC |
| 14:15 | | 1900 | PLT | 9999999999 | 89 | | | | | | |
| 14:15 | | 1900 | PLT | 9999999999 | 89 | | | | 9000 | | |
| 16:30 | | | PLT | 1 | 71 | 111 | 50 | | 60 | | |
| 16:35 | Admitted | 1900 | FFP | | | | | 9.0 | | 5.0 | |
| 17:30 | | 99 | FFP | | 72 | 115 | 58 | 6.6 | | 14.0 | incomplete |
| 18:30 | | 99 | PRBC | | 99 | 119 | 54 | 9.0 | | | |
| 20:13 | | 1900 | PLT | | | | | | 103 | | |
| 21:05 | | 99 | PRBC | | 82 | 82 | 47 | | | | |
| 22:00 | | 1100 | PRBC | | 121 | 150 | 61 | | | | |
| 22:40 | | | | | 83 | 151 | 68 | | | | |
| 23:10 | | | | | | | | | | 157.1 | |
| 23:50 | | 101 | FFP | | 101 | 110 | 59 | | 6000 | 14.0 | |
| 1:10 | | 1400 | PLT | | 84 | 138 | 96 | 8.8 | 100 | 14.0 | |

TABLE 5

| | | | Unit | | BP | BP | | | | | |
|---|---|---|---|---|---|---|---|---|---|---|---|
| Time | Event | Product | # | Pulse | s | d | HGB | PLT | PT | PCC | Comment |
| 17:18 | | | | | | | 11.2 | 52 | | | |
| 21:49 | Admitted | | | | | | | | | | |
| 4:00 | | | | | | | | 41 | 20.0 | | |
| 6:41 | | PRBC | 8701544 | 89 | 118 | 74 | | | | | No start/stop time |
| | | | | | | | | | | | documented or post- |
| | | | | | | | | | | | transfusion vital signs. |
| 8:15 | | PLT | 8020238 | 87 | 123 | 77 | | | | | |
| 8:45 | | | | 96 | 123 | 72 | | | | | |
| 9:05 | | FFP | 8243054 | 86 | 123 | 72 | | | | | No post-transfusion vital |
| | | | | | | | | | | | signs documented. |
| 12:50 | | FFP | 8018357 | 97 | 125 | 68 | | | | | No post-transfusion vital |
| | | | | | | | | | | | signs or time |
| | | | | | | | | | | | documented. |
| 13:39 | | FFP | 8240960 | 87 | 112 | 66 | | | | | Time of post-transfusion |
| | | | | | | | | | | | vital signs not |
| | | | | | | | | | | | documented. |
| | | | | 86 | 120 | 72 | | | | | |
| 22:05 | | PRBC | 8521236 | 80 | 111 | 66 | | | | | |
| 0:30 | | | | 78 | 105 | 66 | | | | | |
| 0:38 | | | | | | | | | 19.7 | | |
| 0:45 | | FFP | 8018595 | 97 | 113 | 71 | | | | | |
| 0:45 | | FFP | 8242822 | 97 | 113 | 71 | | | | | |
| 2:50 | | | | 71 | 106 | 64 | | | | | |
| 2:50 | | PRBC | 8244849 | 71 | 106 | 64 | | | | | Only one verification |
| | | | | | | | | | | | signature. |
| 4:38 | | | | | | | | | 18.5 | | |
| 4:38 | | | | | | | | 37 | | | |
| 5:00 | | | | 73 | 120 | 68 | | | | | |
| 7:00 | | PRBC | 8521259 | 71 | 117 | 68 | | | | | |
| 7:50 | | | | 68 | 117 | 69 | | | | | |
| 7:50 | | PRBC | 8245796 | 70 | 117 | 69 | | | | | |
| 8:30 | | | | 70 | 121 | 66 | | | | | |
| 8:40 | | PRBC | 8245772 | 71 | 121 | 66 | | | | | |
| 9:25 | | | | 64 | 118 | 60 | | | | | |
| 18:40 | | | | | | | | | 15.4 | | |
| 9:00 | | FFP | 8243646 | 78 | 93 | 35 | | | | | |
| 9:30 | | | | 44 | 121 | 62 | | | | | |
| 10:15 | | FFP | 8520821 | 49 | 121 | 62 | | | | | Only one verification |
| | | | | | | | | | | | signature, without vital |
| | | | | | | | | | | | signs or stop time. |
| 5:12 | | | | | | | | 29 | | | |
| 5:15 | | | | | | | | | 16.8 | | |
| 13:15 | | PLT | 8020339 | | | | | | | | Only one verification |
| | | | | | | | | | | | signature, without vital |
| | | | | | | | | | | | signs or stop time. |
| 13:24 | OR In. Ash | | | | | | | | | | |
| | cath | | | | | | | | | | |
| | insertion. | | | | | | | | | | |
| 14:57 | OR Out. | | | | | | | | | | |
| | EBL 25 mL | | | | | | | | | | |
| 6:00 | | | | | | | | 41 | | | |
| 6:25 | | | | | | | | | 15.7 | | |
| 7:05 | | | | | | | | 78 | | | |
| 14:15 | | PLT | 8020423 | 81 | 86 | 53 | | | | | |
| 14:58 | | | | | | | | 78 | | | |
| 15:05 | | | | 86 | 111 | 67 | | | | | |
| 1:30 | | | | 120 | 112 | 79 | | | | | |
| 2:20 | | | | 94 | 107 | 69 | | | | | |
| 12:09 | | PRBC | 8246137 | 94 | 107 | 66 | | | | | |
| 12:50 | | PRBC | 8246175 | 96 | 163 | 60 | | | | | |
| 18:27 | Discharged | | | | | | | | | | |
| 0:01 | Admitted | | | | | | | | | | |
| 13:48 | | PRBC | 8246710 | 72 | 99 | 63 | | | | | No start time or date |
| | | | | | | | | | | | documented. |
| 13:59 | | | | | | | | | 16.5 | | Not recorded. |
| 14:15 | | | | | 99 | 88 | | | | | |
| 14:40 | | PRBC | 8522397 | 71 | 94 | 57 | | | | | |
| 16:00 | | FFP | 8245584 | 87 | 101 | 64 | | | | | |
| 16:00 | | | | 87 | 101 | 64 | | | | | |
| 16:35 | | | | 63 | 90 | 58 | | | | | |
| 16:35 | | FFP | 8521727 | 63 | 90 | 58 | | | | | |
| 17:00 | | | | 87 | 85 | 52 | | | | | |
| 17:20 | | FFP | 8520850 | 83 | 94 | 53 | | | | | |
| 17:50 | | FFP | 8244379 | 85 | 96 | 52 | | | | | |
| 17:50 | | | | 84 | 96 | 52 | | | | | |
| 18:20 | | | | 84 | 105 | 54 | | | | | |
| 20:00 | | FFP | 8244082 | 80 | 113 | 69 | | | | | |
| 20:13 | | FFP | 8019502 | 103 | 104 | 68 | | | | | Time of post-transfusion |
| | | | | | | | | | | | vitals not documented. |
| | | | | 80 | 113 | 69 | | | | | |
| 20:25 | | | | 87 | 108 | 68 | | | | | |
| 23:59 | Discharged | | | | | | | | | | |

TABLE 6

| Date | Time | Event | Units | BP | Pulse | HGB | PLT | PT |
|---|---|---|---|---|---|---|---|---|
| Day 1 | 17:18 | | | | | 11.2 | 52 | |
| | 21:49 | Admitted | | | | | | |
| Day 3 | 4:00 | | | | | | 41 | 20 |
| | 6:41 | PRBC 8701544 | 1 | 118/74 | 89 | | | |
| | 8:15 | PLT 8020238 | 1 | 123/77 | 87 | | | |
| | 8:45 | | | 123/72 | 96 | | | |
| | 9:05 | FFP 8243054 | 1 | 123/72 | 86 | | | |
| | 12:50 | FFP 8018357 | 1 | 125/68 | 97 | | | |
| | 13:39 | FFP 8240960 | 1 | 112/66 | 87 | | | |
| | | | | 120/72 | 86 | | | |
| | 22:05 | PRBC 8521236 | 1 | 111/66 | 80 | | | |
| Day 4 | 0:30 | | | 105/66 | 78 | | | |
| | 0:38 | | | | | | | 19.7 |
| | 0:45 | FFP 8018595 | 1 | 113/71 | 97 | | | |
| | 0:45 | FFP 8242822 | 1 | 113/71 | 97 | | | |
| | 2:50 | | | 106/64 | 71 | | | |
| | 2:50 | PRBC 8244849 | 1 | 106/64 | 71 | | | |
| | 4:38 | | | | | | | 18.5 |
| | 4:38 | | | | | | 37 | |
| | 5:00 | | | 120/68 | 73 | | | |
| | 7:00 | PRBC 8521259 | 1 | 117/68 | 71 | | | |
| | 7:50 | | | 117/69 | 68 | | | |
| | 7:50 | PRBC 8245796 | 1 | 117/69 | 70 | | | |
| | 8:30 | | | 121/66 | 70 | | | |
| | 8:40 | PRBC 8245772 | 1 | 121/66 | 71 | | | |
| | 9:25 | | | 118/60 | 64 | | | |
| Day 7 | 18:40 | | | | | | | 15.4 |
| Day 8 | 9:00 | FFP 8243646 | 1 | 93/35 | 78 | | | |
| | 9:30 | | | 121/62 | 44 | | | |
| | 10:15 | FFP 8520821 | 1 | 121/62 | 49 | | | |
| Day 9 | 5:12 | | | | | | 29 | |
| | 5:15 | | | | | | | 16.8 |
| | 13:15 | PLT 8020339 | 1 | | | | | |
| | 13:24 | OR In. Ash cath | | | | | | |
| | | insertion. | | | | | | |
| | | OR Out. EBL | | | | | | |
| | 14:57 | 25 mL. | | | | | | |
| Day 10 | 6:00 | | | | | | 41 | |
| Day 11 | 6:25 | | | | | | | 15.7 |
| Day 14 | 7:05 | | | | | | 78 | |
| | 14:15 | PLT 8020423 | 1 | 86/53 | 81 | | | |
| | 14:58 | | | | | | 78 | |
| | 15:05 | | | 111/67 | 86 | | | |
| Day 15 | 1:30 | | | 112/79 | 120 | | | |
| | 2:20 | | | 107/69 | 94 | | | |
| | 12:09 | PRBC 8246137 | 1 | 107/66 | 94 | | | |
| | 12:50 | PRBC 8246175 | 1 | 163/60 | 96 | | | |
| Day 16 | 18:27 | Discharged. | | | | | | |
| Day 22 | 0:01 | Admitted | | | | | | |
| | 13:48 | PRBC 8246710 | 1 | 99/63 | 72 | | | |
| | 13:59 | | | | | | | 16.5 |
| | 14:15 | | | 99/88 | not | | | |
| | | | | | documented. | | | |
| | 14:40 | PRBC 8522397 | 1 | 94/57 | 71 | | | |
| | 16:00 | FFP 8245584 | 1 | 101/64 | 87 | | | |
| | 16:00 | | | 101/64 | 87 | | | |
| | 16:35 | | | 90/58 | 63 | | | |
| | 16:35 | FFP 8521727 | 1 | 90/58 | 63 | | | |
| | 17:00 | | | 85/52 | 87 | | | |
| | 17:20 | FFP 8520850 | 1 | 94/53 | 83 | | | |
| | 17:50 | FFP 8244379 | 1 | 96/52 | 85 | | | |
| | 17:50 | | | 96/52 | 84 | | | |
| | 18:20 | | | 105/54 | 84 | | | |
| | 20:00 | FFP 8244082 | 1 | 113/69 | 80 | | | |
| | 20:13 | FFP 8019502 | 1 | 104/68 | 103 | | | |
| | | | | 113/69 | 80 | | | |
| | 20:25 | | | 108/68 | 87 | | | |
| | 23:59 | Discharged. | | | | | | |

Such a centralized computer database accessible remotely by clinical reviewers also contains, in addition to the relevant laboratory results, clinical observations, and transfusion history for each patient, the results of the clinical reviewer's determination of whether utilization of one or more medical products such as a transfusion was appropriate or effective. The degree of appropriateness may be scored using any recognized scoring system. From the data assimilated from each patient, the utilization history and patterns of each healthcare provider and each healthcare institution may be analyzed. Such analysis provides valuable data useful for instructing and modifying utilization behavior to conform to contemporary medical standards of practice. Also, such analysis provides valuable data useful for determining practice trends among one or more healthcare providers or healthcare facilities and for determining performance of healthcare providers.

Many factors may be considered in determining whether a transfusion event is appropriate under the contemporary medical standards of practice. In fact, the standards themselves may change over time as further clinical understanding is obtained. Some particularly useful parameters include hemoglobin levels, PT levels and platelet counts. For instance, lower level blood hemoglobin values of 6 g/dL may be acceptable in healthy individuals, while only 7-8 g/dL may be acceptable in moderately ill patients and 9 g/dL or more may be required in severely ill patients. Likewise, a PT time of less than 15 seconds may be acceptable for patients having active bleeding or anticipating surgery while less than 18-20 seconds may be acceptable for severely threatened patients. Similarly, platelet count thresholds may be greater than 10,000 or 20,000 for healthy patients while greater than 50,000 may be desirable for patients having active bleeding.

In some particular embodiments, clinical observations that are indicative of the need for transfusion of a blood product include an estimated blood loss of greater than 1800 ml in a patient less than 30 years of age; an estimated blood loss of greater than 1300 ml in a patient greater than 55 years of age; a hemoglobin of less than 6.0 g/dL in a patient less than 30 years of age; a hemoglobin of less than 7.0 g/dL in a patient greater than 55 years of age; a prothrombin time (PT) of greater than 23.0; a platelet count of less than 10,000; a pulse rate greater than 120 beats per minute; a systolic blood pressure less than 80; and a diastolic blood pressure less than 50.

In other particular embodiments, clinical observations that are indicative that packed red blood cells (PRBC) transfusion is or was unnecessary include estimated blood loss less than 1000 ml 48 hours prior to PRBC transfusion in a patient older than 55; estimated blood loss less than 1500 ml in 48 hours prior to PRBC transfusion in a patient younger than 30; hemoglobin greater than 8.7 g/dL six hours prior to PRBC transfusion in a patient older than 55; hemoglobin greater than 6.5 g/dL prior to PRBC transfusion in a patient younger than 30; pulse less than 100 six hours prior to PRBC transfusion; systolic blood pressure greater than 110 six hours prior to PRBC transfusion; diastolic blood pressure greater than 60 six hours prior to PRBC transfusion; no hemoglobin value obtained within 6 hours prior to PRBC transfusion; no pre-transfusion hemoglobin at all; no hemoglobin within 6 hours following PRBC transfusion; no post-transfusion hemoglobin at all; a discharge hemoglobin greater than 10.0 g/dL and in a patient over 49 years old; and a discharge hemoglobin greater than 9.0 g/dL in a patient less than 50 years old.

In other particular embodiments, clinical observations that are indicative that fresh frozen plasma (FFP) is or was not needed include a prothrombin time of less than 15.1 within 6 hours of FFP transfusion; a prothrombin time of less than 18.1 and an estimated blood loss of less than 100 ml 12 hours following FFP transfusion; a corrected PT of less than 0.30 where the corrected value is calculated as (Post-PT−Pre-PT)/Pre-PT and where Pre-PT is PT within 6 hours preceding FFP transfusion and Post-PT is PT within 6 following FFP transfusion; no pre-transfusion PT prior to FFP transfusion; no PT less than 6 hours preceding FFP transfusion; no PT less than 4 hours following FFP transfusion; and no post-transfusion PT following FFP transfusion.

In other particular embodiments, clinical observations that are indicative that a transfusion of platelets is or was unnecessary include a platelet count of greater than 50,000 within 24 hours of platelet transfusion; a platelet count of greater than 20,000 and an estimated blood loss of less than 100 ml 12 hours following platelet transfusion; a corrected platelet count of less than 0.30 where the corrected platelet count is calculated as (Post-PLT−Pre-PLT)/Pre-PLT where the Pre-PLT is the platelet count within 6 hours preceding platelet transfusion and the Post-PLT is the platelet count within 6 hours following platelet transfusion; no pre-transfusion platelet count was recorded; no platelet count obtained less than 6 hours preceding platelet transfusion; no platelet count obtained less than 4 hours following platelet transfusion; and no post-transfusion platelet count obtained.

In other particular embodiments, clinical observations that are indicative that any transfusion of any blood product is or was unnecessary include no pre-transfusion pulse was recorded; no post-transfusion pulse was recorded; no pre-transfusion blood pressure was recorded; no post-transfusion blood pressure was recorded; no pre-transfusion time recorded and no post-transfusion time recorded.

There are substantial differences in the clinical use of blood products among healthcare providers and institutions reflecting a lack of consensus about specific criteria for their appropriate use. Existing guidelines also vary, and strategies for changing transfusion practice have had mixed effectiveness. Sound evidence on which to base firm conclusions regarding the efficacy or appropriateness of a transfusion under particular clinical circumstances is lacking.

Clinical judgment of the balance of risks and benefits is crucial to every decision of whether to transfuse. There may be significant variations in the situations where transfusion with a blood product is appropriate. For instance, in the case of red cells, the patient's hemoglobin level is not the only factor to be considered, but must be viewed alongside signs and symptoms of tissue hypoxia, ongoing blood loss, risk to the patient of anemia, etc. Use of red blood cells is likely to be inappropriate when the hemoglobin level is greater than 100 g/L unless there are specific indications warranting transfusion. Similarly, transfusion of red blood cells is likely to be appropriate when the hemoglobin level is less than 70 g/L. In the range between 70-100 g/L clinical judgment considering a host of factors is of great importance. Transfusion of red blood cells is likely warranted if the patient is undergoing a major surgical procedure associated with major blood loss, there are signs of associated impairment in oxygen transport that may be exacerbated by anemia, or to control anemia related symptoms such as those occurring during bone marrow suppression therapy.

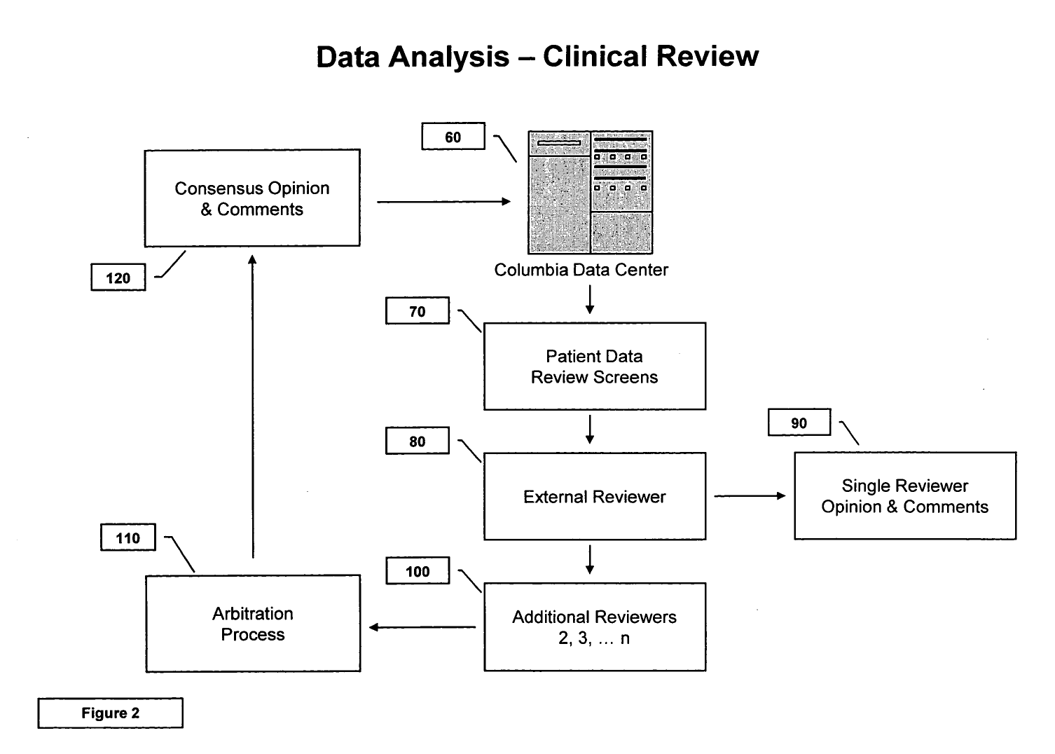

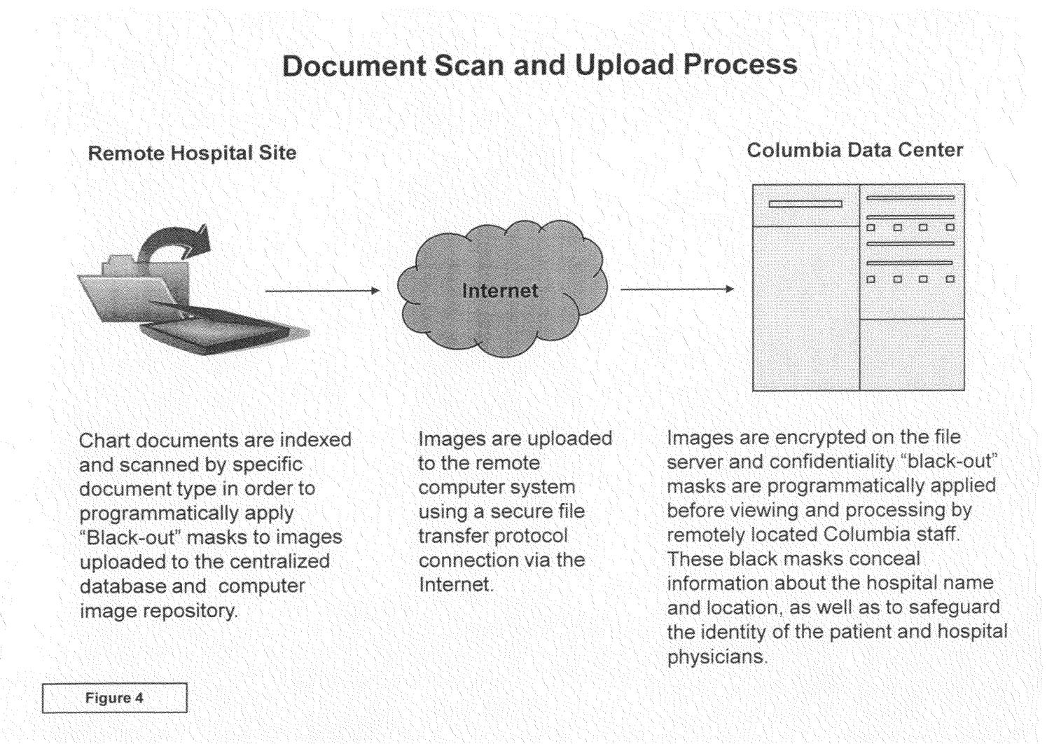

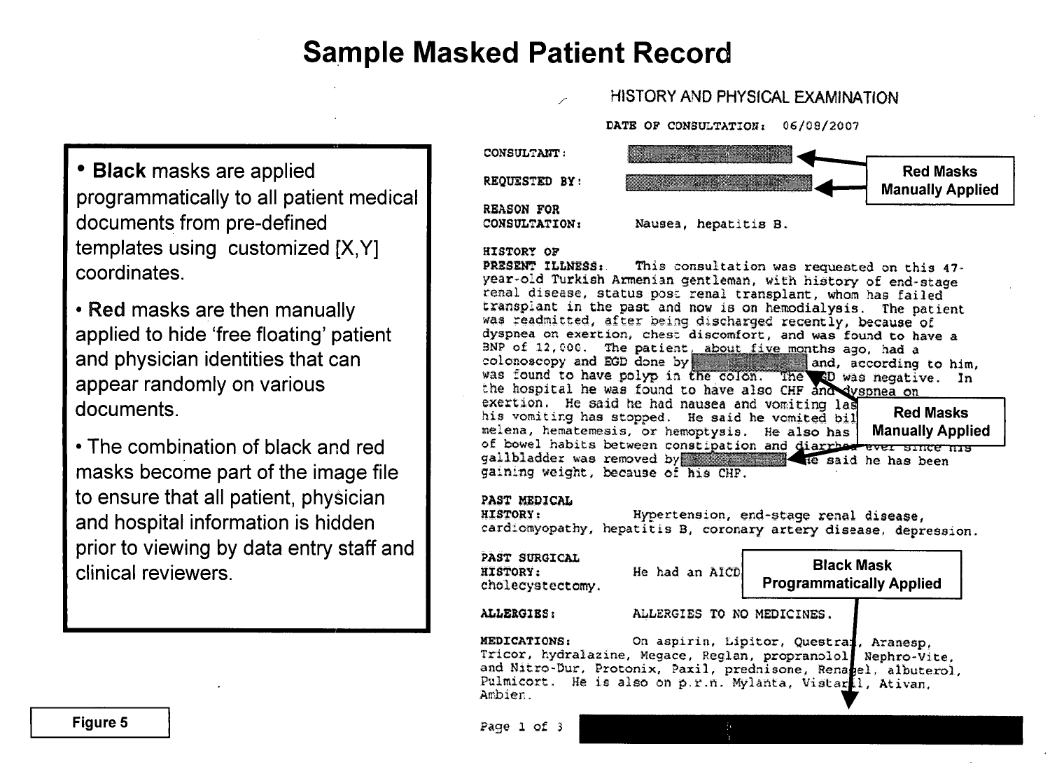

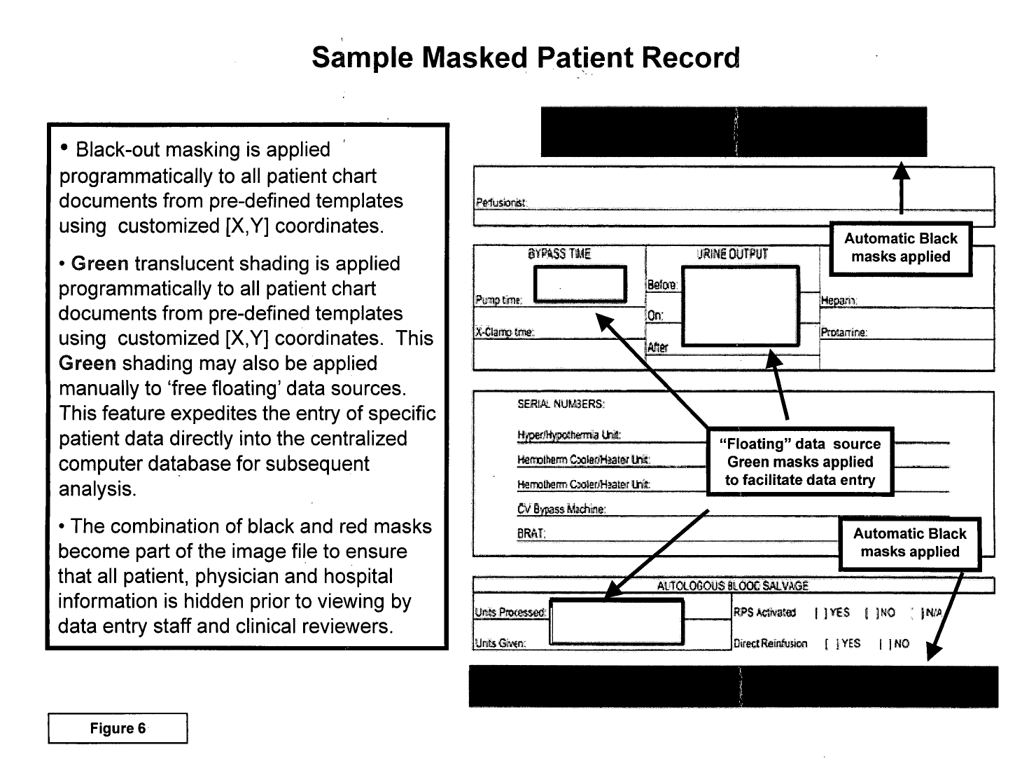

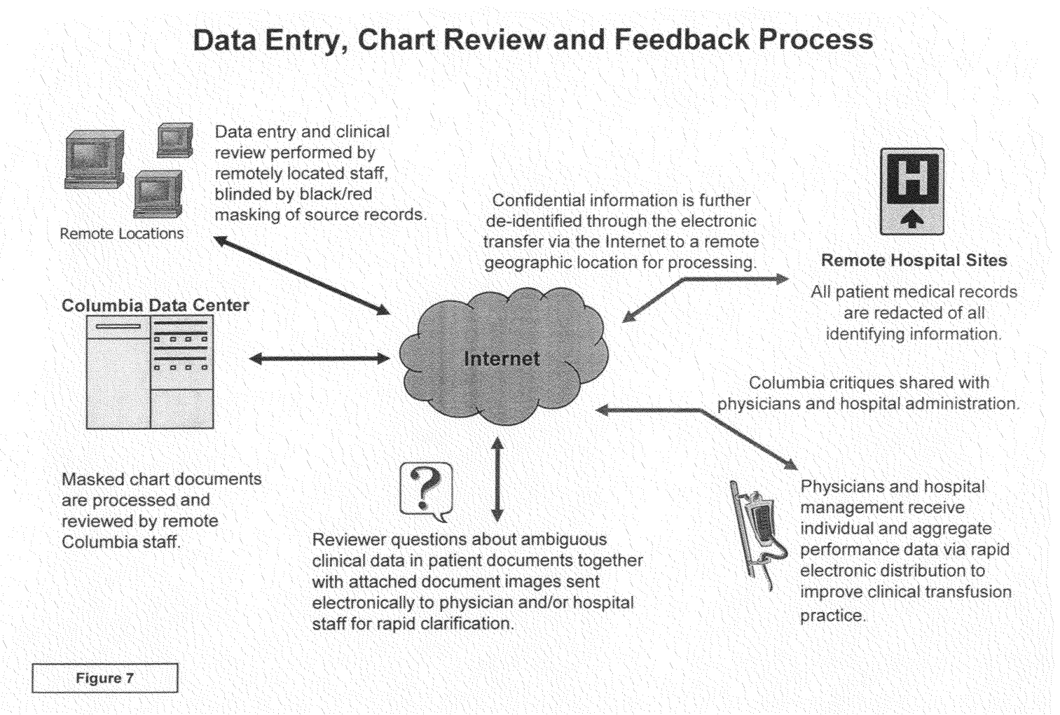

The present invention provides that redacted information is available to multiple reviewers, inside and outside the healthcare organization, via dissemination through the worldwide web. This provides a marked advantage to current systems that do not generally provide for external review, especially via the worldwide web. In one embodiment shown in FIG. 2, one or more patient data review screens 70 are available for review by an external reviewer 80 who may be a single reviewer 90 or multiple reviewers 100. The single reviewer 90 provides opinion and comments directly to the database 60. The multiple reviewers 100 may go through an arbitration process 110 to provide a consensus opinion and comments 120 to the database 60. Further embodiments of the invention are shown in a document scan and upload process as illustrated in FIG. 4 and in FIGS. 5, 6 and 7.

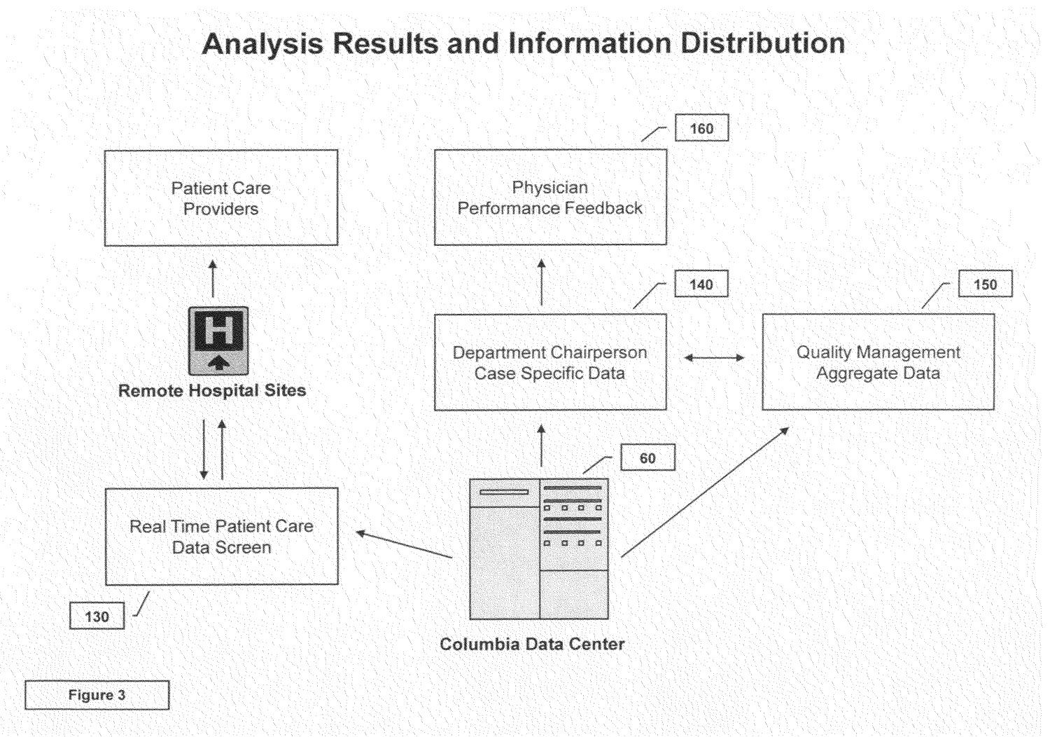

The present invention further provides that data is available for analysis while patient care is being provided. Analysis of the appropriateness of therapy may be performed on a regular and routine basis. This provides yet another marked advantage to current systems that generally provide only for retrospective analysis. As shown in one embodiment in FIG. 3, data is provided from the database 60 in real time for display on a patient care data screen 130 for a clinical reviewer for analysis of the data and to provide the analysis to a hospital 140 and patient care providers 150 who can then provide data directly to the clinical reviewer for display on the patient care data screen 130. Case specific data 160 or aggregate data 170 reflecting quality management may also be provided to a Department Chairperson or others to provide performance feedback 180 to attending physicians or other healthcare providers.

The present invention further provides for accumulating the most relevant data for determining whether blood product therapy is appropriate in a convenient and easy to read manner. Because the relevant data is accessible remotely, it may be reviewed by clinical reviewers at distant healthcare facilities both providing for significant elimination of bias and affording the opportunity of using external reviewers having optimal training and expertise in utilization review. This facilitates review of an individual patient or event or of multiple patients and events in a blind manner. Therefore, a clinician may even be blinded to the identity of his or her own patient and thereby review his own practice in a blind manner.

In further embodiments of the invention, the relevant laboratory results and clinical observations are formatted in a manner that incorporates Boolean logical operations based upon flexible appropriateness and effectiveness rules that flag (A) appropriate, borderline and inappropriate circumstances, as well as (B) effective, indeterminant and ineffective outcomes. This provides for rule-based decision-making.

While the present disclosure and the attached figures provide specific embodiments of the methods and databases, those skilled in the art will appreciate from this disclosure that variations, modifications and equivalents of the specific elements suggested by the present disclosure come within the scope of this invention. Hence, the embodiments described herein are intended to be illustrative, rather than restrictive. Variations and changes may be made without departing from the spirit and scope of the present invention. Accordingly, the scope of this invention should not be construed as being limited to the specifics of the detailed disclosure and best mode disclosed herein.

What is claimed is:

1. A method of determining whether a transfusion of a blood product to a patient is or was appropriate comprising:
(a) obtaining relevant laboratory or clinical information regarding the patient;
(b) entering the relevant laboratory or clinical information regarding the patient into a database;
(c) transmitting the relevant laboratory or clinical information regarding the patient to a clinical reviewer; and
(d) comparing the relevant laboratory or clinical information regarding the patient to established medical practice standards.

2. The method according to claim 1 wherein the relevant laboratory or clinical information is selected from the group consisting of a patient's hemoglobin or hematocrit levels, platelet count, age, blood pressure, weight, pulse, estimated blood loss, PT, PTT, and fibrinogen levels.

3. The method according to claim 1 wherein the relevant laboratory or clinical information is obtained before transfusion with a blood product.

4. The method according to claim 1 wherein the relevant laboratory or clinical information is obtained after transfusion with a blood product.

5. The method according to claim 1 wherein the blood product is selected from the group consisting of red blood cells, platelets and fresh frozen plasma (FFP).

6. The method according to claim 1 wherein the transmitting is performed via the worldwide web.

7. A method of evaluating blood product transfusion of a healthcare provider or healthcare institution comprising
(a) obtaining utilization information stored in a computer system
(b) obtaining relevant laboratory or clinical information regarding patients receiving transfusions;
(c) correlating the amount of blood product transfused with the relevant laboratory or clinical information; and
(d) determining whether the transfusion is or was appropriate according to established medical practice standards.

8. The method according to claim 7 wherein the relevant laboratory or clinical information is selected from the group consisting of a patient's hemoglobin or hematocrit levels, platelet count, age, blood pressure, weight, pulse, estimated blood loss, PT, PTT, and fibrinogen levels.

9. The method according to claim 7 wherein the relevant laboratory or clinical information is obtained before transfusion with a blood product.

10. The method according to claim 7 wherein the relevant laboratory or clinical information is obtained after transfusion with a blood product.

11. The method according to claim 7 wherein the blood product is selected from the group consisting of red blood cells, platelets and fresh frozen plasma (FFP).

12. The method according to claim 7 wherein the obtaining is performed via the worldwide web.

13. A programmable computer system for use in determining whether transfusion with a blood product is or was appropriate, comprising a central processing unit, a system memory, a display device, an input device, and a control device, wherein said central processing unit is enabled with a software application capable of generating a display of medical data, said central processing unit further comprising an operating system capable of interfacing with said software application, said system memory capable of storing data in user-defined, sortable databases, said control device capable of directing activity of said software application.

14. The system of claim 13, wherein said software application is capable of assigning a clinical score in response to one or more relevant laboratory or clinical information data and wherein said clinical score is indicative of the degree transfusion with a blood product is or was warranted.

15. The system of claim 13, wherein said operating system is selected from the group comprising Macintosh, DOS, Windows, Windows NT, OS/2, OS/3, and Unix.

16. The system of claim 13, wherein said input device is selected from the group consisting of a keyboard, bar code reader, touch screen, scanner, voice recognition and combinations thereof.

17. The system of claim 13, wherein said system memory is a system hard drive.

18. The computer system of claim 13, wherein said auxiliary memory is selected from the group comprising a floppy disk, CD Rom, Internet server memory storage device, network drive, or server.

19. A medical information database in a programmable computer system for use in tracking transfusion activity wherein the medical information database is accessible by at least one external reviewer via the worldwide web.

20. An improved patient medical information database for use in evaluating blood product transfusion of a healthcare provider or a healthcare institution, wherein the improvement comprises a communication link whereby the information database is accessible to a clinical reviewer remotely or via the worldwide web.

21. An improved patient medical information database for use in evaluating blood product transfusion of a healthcare provider or a healthcare institution, wherein the improvement comprises a three tier process applied to the patient medical records so that patient, physician and hospital information is masked prior to processing by external utilization and evaluation by peer reviewers.

22. An improved patient medical information database for use in evaluating blood product transfusion of a healthcare provider or a healthcare institution, wherein the improvement comprises the application of black opaque masks and the application of red opaque masks to patient medical records followed by the routing of the masked medical records via the Internet to external reviewers while the confidentiality of the patient, the physician and the healthcare facility is maintained.
